(19) United States
(12) Patent Application Publication
(10) Pub. No.: US 2024/0021199 A1
(43) Pub. Date: Jan. 18, 2024

(54) RECEIVING DEVICE AND METHOD FOR VOICE COMMAND PROCESSING

(71) Applicants: HISENSE VISUAL TECHNOLOGY CO., LTD., Shandong (CN); TVS REGZA CORPORATION, Kawasaki (JP)

(72) Inventors: Dai ISHIMARU, Kawasaki (JP); Yuji IRIE, Kawasaki (JP)

(21) Appl. No.: 18/356,485

(22) Filed: Jul. 21, 2023

Related U.S. Application Data
(63) Continuation of application No. PCT/CN2021/118683, filed on Sep. 16, 2021.

(30) Foreign Application Priority Data
Jan. 21, 2021 (JP) 2021-008062

(51) Int. Cl. G10L 15/22; G10L 15/30; H04N 21/422; H04N 21/472

(52) U.S. Cl. CPC G10L 15/22; G10L 15/30; H04N 21/42203; H04N 21/472; G10L 2015/223

(57) ABSTRACT

A receiving device and method for voice command processing. The receiving device includes a voice data receiving component, configured to receive voice data from a user; a communication component configured to communicate with an external device; a voice recognition component, configured to perform voice recognition on voice data and outputting a recognition result; a determination component, configured to determine whether a first voice command corresponding to a first recognition result exists in a database of the receiving device, wherein an association is established between information of the first voice command for controlling the receiving device and information of a first local instruction inside the receiving device for command execution of the first voice command; and a server data receiving component, configured for acquiring information of the database from a server based on a determination result from the determination component.

### CROSS REFERENCE TO RELATED APPLICATION

This application is a continuation application of PCT/CN2021/118683, which claims the priority to Japanese Patent Application No. 2021-008062, filed with the Japanese Patent Office on Jan. 21, 2021. The entire contents of which are incorporated herein by reference.

### TECHNICAL FIELD

The embodiments of the present disclosure relate to a circuit, receiving device and server for voice command processing, a voice command accumulation system, a voice command accumulation method, and a non-transitory storage medium.

### BACKGROUND

In recent years, home appliances that can be remotely controlled by voice commands by humans have become widespread by using voice recognition. In a television receiving device with digital broadcasting, simple voice recognition such as a specific voice mode is arranged inside (i.e., locally at) the television receiving device, and complex and random voice recognition, such as a voice mode that requires semantic understanding or natural language processing, etc., are performed by an external server such as a combined cloud server, to thereby realize advanced voice recognition.

### RELATED ART

### Patent Documents

Patent 1: Japanese Patent Publication No. 2015-535952;
Patent 2: Japanese Patent Publication No. 2019-15952.

### SUMMARY

However, in order to allow users to freely issue voice commands in a form closer to natural language, an external server having advanced functions such as natural language processing is usually required.

In embodiments of the present disclosure, the receiving device for voice command processing performs voice recognition on voice data and outputs a recognition result, and determines whether a voice command corresponding to the recognition result exists in a database, wherein an association between information of voice commands for controlling a device and information of control commands inside the device (i.e., local instructions) for command execution of the voice commands is established in the database; and the receiving device obtains information in the database from a server based on a determination result from a determination component.

### BRIEF DESCRIPTION OF FIGURES

FIG. 1 is a functional block diagram showing a structure of a system according to embodiments.

FIG. 2 is a functional block diagram showing a structure of a receiving device according to some embodiments.

FIG. 3 is a functional block diagram showing a structure of a voice command processing component according to some embodiments.

FIG. 4 is a functional block diagram showing a structure of a server according to some embodiments.

FIG. 5 is a diagram showing examples of voice commands that are processed by a voice command processing component according to a first embodiment.

FIG. 6 is a flowchart showing examples of processing operations for a voice signal processed by a voice command processing component according to the first embodiment.

FIGS. 7A and 7B are diagrams showing examples of a database in a local voice command database in a receiving device according to the first embodiment.

FIG. 8 is a flowchart showing examples of processing operations of creating local voice data by the voice command processing component according to the first embodiment.

FIG. 9 is an example of local voice data stored in the voice command processing component according to the first embodiment.

FIG. 10 is a flowchart showing examples of processing operations for voice data in the server according to the first embodiment.

FIG. 11 is an example of a database stored in the server according to the first embodiment.

FIGS. 12A and 12B are examples of a database used by the voice command processing component to process voice commands received from multiple users according to the first embodiment.

FIG. 13 is a diagram showing examples of voice commands that are processed by the voice command processing component according to the first embodiment.

FIG. 14 is an example of server command information stored in a voice command processing component according to a second embodiment.

FIG. 15 is an example of a database stored in the voice command processing component according to a third embodiment.

FIG. 16 is a flowchart showing examples of processing operations in a case where the server selects a server command from multiple server commands and transmits the server command to the voice command processing component according to the third embodiment.

FIGS. 17A and 17B are functional block diagrams showing a structure of a modified system.

### REFERENCE NUMERALS

1 . . . receiving device; 2 . . . voice command processing component; 3 . . . server; 5 . . . network; 10 . . . remote controller; 11 . . . tuner; 12 . . . broadcast signal reception processing component; 13 . . . communication component; 14 . . . content processing component; 15 . . . presenting control component; 16 . . . presenting component; 17 . . . control component; 18 . . . interface component; 19 . . . record and playback component; 21 . . . voice recognition component; 22 . . . determination component; 23 . . . local instruction processing component; 24 . . . server data acquisition component; 25 . . . server command database; 26 . . . local voice command generation component; 27 . . . local voice command database; 31 . . . communication component in the server; 32 . . . control component in the server; 33 . . . text conversion component; 34 . . . natural language processing component; 35 . . . server command generation component; 36 . . . reply voice generation component; 37 . . . inherent data storage component; 38 . . . common data storage component; 101 . . . data storage component; 261 . . . high frequency filter; 262 . . . condition setting component; 371 . . . receiving device data storage component; 372 . . . local instruction data storage component; 381 . . . common information data storage component; 382 . . . server command data storage component.

### DETAILED DESCRIPTION

Embodiments are described below with reference to the drawings.

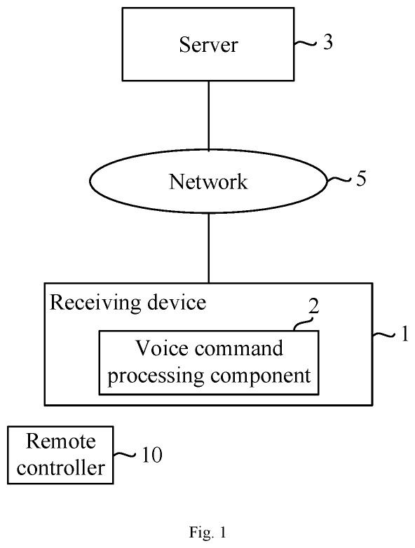

FIG. 1 is a functional block diagram showing a structure of a system according to embodiments of the present disclosure.

A receiving device 1 is configured for viewing digital content. For example, the receiving device 1 is a receiving device of television signal (also referred to as a television device, a television receiving device, or a broadcast signal receiving device) that can receive digital broadcasting signals such as terrestrial broadcasts such as 2K or 4K/8K, satellite broadcasting, etc. Digital content obtained from digital broadcasting is also referred to as a broadcast program.

The receiving device 1 may have a digital signal processing structure such as a central processing unit (CPU), a memory, and a digital signal processor (DSP), and can perform control using a voice recognition technology. For example, when a user issues a command by voice, the voice is received by a voice collecting function such as a voice receiver (hereinafter, also referred to as a microphone in some cases) in the receiving device 1; and a voice command processing component 2 extracts the command by using the voice recognition technology or the like, and controls various functions of the receiving device 1 by using the command extracted. In addition, the receiving device 1 in the embodiments of the present disclosure may perform a control from a long-distance controller 10 (hereinafter, also referred to as a remote controller 10 in some cases). Specifically, in addition to normal functions of the remote controller such as power on and off, for example, a microphone of the remote controller 10 receives a user's voice, and transmits the user's voice to the receiving device 1 as voice data. The receiving device 1 controls various functions of the receiving device 1 according to the voice data received, such as extracting a command via the voice recognition technology. The receiving device 1 in the embodiments of the present disclosure outputs a control signal generated based on the command extracted to a record and playback component 19 to control the record and playback component 19.

In addition, the receiving device 1 has a communication function for connecting with a network 5 such as the Internet, and can interact data with various servers (which may include servers constructed based on cloud) via the network 5. For example, digital content can also be obtained from a content server (not shown) connected via the network 5. The digital content acquired from the content server may also be called network content.

The voice command processing component 2 may also have a digital signal processing component such as a CPU, a memory, and a DSP, and may have functions such as a voice recognition technology. The voice command processing component 2 can control internal functions of the receiving device 1 by extracting commands from user's voice. The voice command is a command from the user to the receiving device 1 in the form of voice so as to control the receiving device 1. In a case where the voice command is associated with an internal command (hereinafter, also referred to as a local instruction in some cases) for controlling the functions of the receiving device 1, the receiving device 1 can control the functions of the receiving device 1 by receiving the voice command. For example, in a case that a voice command such as “increase the volume” for increasing the volume output of the speaker in the receiving device 1 is associated with a local instruction (such as volume_up) of the receiving device 1, when the user utters “increase the volume” to the receiving device 1, the receiving device 1 executes volume_up and the volume of the speaker in the receiving device 1 increases. As the voice command for increasing the volume of the speaker, not only “increase the volume” but also various variations such as “add volume”, “volume up”, and “improve volume” are considered. Since the voice command processing component 2 of the embodiments of the present disclosure associates such variations with the same local instruction (volume_up), natural language processing can also be used.

In addition, FIG. 1 shows an example where only one receiving device 1 is connected with the network 5. A plurality of receiving devices 1 may be connected with the network 5. In addition, it is not necessary for each of the plurality of receiving devices 1 to have the same function, and the manufacturer is also not limited.

A server 3 is a server that is on the network 5 and capable of performing voice recognition, and includes, for example, a computer having a CPU, a memory, and the like, and may have a digital signal processing component such as a DSP. The server 3 can also be constructed as a cloud server. The server 3 has a voice recognition technology. The server 3 is capable of performing voice recognition, receives digital data (i.e., voice data) of the user's voice received by the microphone of the receiving device 1, etc. via the network 5, estimates or recognizes the user's voice, and uses the recognized voice as text data (also called recognition voice data in some cases) and outputs the text data. The voice recognition technology is a common technology, and detailed explanation is omitted herein.

In addition, the server 3 can perform natural language processing, and can extract local instructions of the receiving device 1 corresponding to the meaning of the language based on the above-mentioned languages such as “add volume”, “volume up”, and “improve volume”. That is, by utilizing natural language processing in the server 3, the user can not only use a specific voice command as a voice command, but also can use an arbitrary language as a voice command. For example, the user utters phrases such as “add volume”, “volume up”, “improve volume”, and the server 3 executes a local instruction (volume_up) in the receiving device 1 to increase the volume of the speaker. In addition, the receiving device 1 may be provided with the function of the server 3, and since the performance of natural language processing can be improved by utilizing large-capacity data such as big data, it is desirable to provide this function in the server 3 constructed using the cloud or the like.

In addition, the server 3 can acquire various information of the receiving device 1 in addition to information such as local instructions of the receiving device 1.

The network 5 is a network, e.g., the Internet, capable of connecting and communicating with the receiving device 1, the server 3, and the like. In addition, the network 5 is not limited to the Internet, and may be a network including a plurality of different networks irrespective of wired or wireless as long as devices can communicate with each other.

The remote controller 10 is a remote controller for remotely controlling the receiving device 1. The remote controller 10 in the embodiments of the present disclosure may include, for example, a voice collecting function such as a microphone capable of receiving user's voice. In addition, the remote controller 10 may have an interface function such as BlueTooth (registered trademark) and WiFi (registered trademark) for externally transmitting the voice data received.

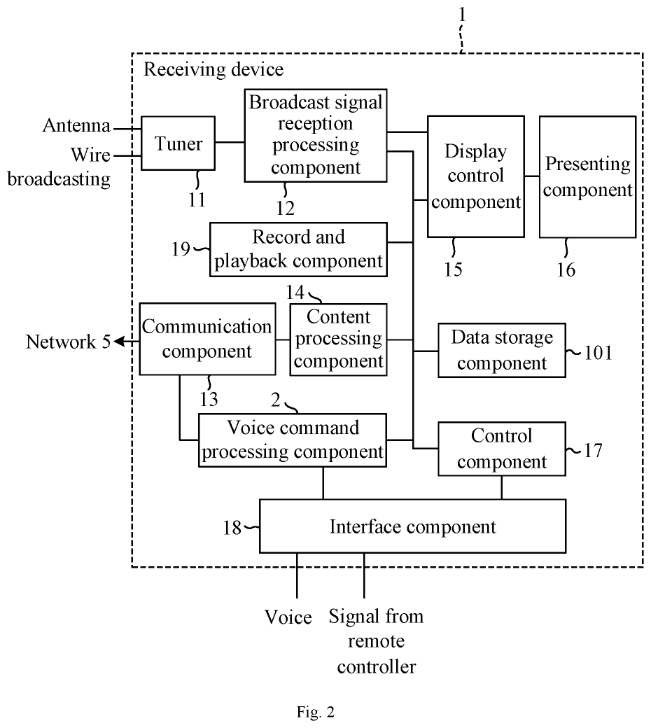

FIG. 2 is a functional block diagram showing a structure of the receiving device according to some embodiments. The tuner 11 receives radio waves in a desired frequency band from an antenna, cable broadcasting, or the like, obtains a broadcast signal (digital data) through demodulation processing, or the like, and outputs the broadcast signal.

A broadcast signal reception processing component 12 processes the broadcast signal from the tuner 11 according to a standard of digital broadcasting, and acquires and outputs content data such as images, audio, and texts. For example, the standard of digital broadcasting may comprise MPEG2 TS used in 2K digital broadcasting, or an MPEG Media Transport (MMT) used in 4K/8K digital broadcasting, or a plurality of tuners may be used to support each other. The processing corresponding to the standard of digital broadcasting includes demultiplexing processing for separating the digital data input from the tuner 11 into a digital data stream of content data such as images, audio, and texts, decoding processing of error correcting codes, decryption processing for encrypted data, decoding processing for encoding (image encoding, audio encoding, text encoding, etc.) performed on content data, and the like.

The communication component 13 is connected with the network 5 and communicates with various servers and devices on the network 5. Specifically, digital data is exchanged by transmission and reception processing corresponding to predetermined communication protocols such as TCP/IP and UDP/IP, for example.

A content processing component 14 receives, for example, content data provided by a content server (not shown) connected with the network 5 via the communication component 13. The content processing component 14 performs decoding processing and the like on the data received via the communication component 13 with respect to the encoding processing performed by the content server, acquires and outputs content data such as images, audio, and texts. More specifically, the content processing component 14 may perform, as decoding processing, demultiplexing processing (separation processing), decoding processing of error correcting codes, decoding processing of coded content data (images, texts, audio, etc.), for example.

A control component 15 adjusts an output time point, display method, and the like with respect to the content data from the broadcast signal reception processing component 12, the content processing component 14, and the record and playback component 19, and outputs adjusted content data. According to the content of the data recorded in the record and playback component 19, the data output from the recording and playback component 19 may be subjected to demultiplexing processing (separation processing), decoding processing of error correcting codes, and decoding processing of coded content data (images, texts, audio, etc.), and then the data is transmitted to the control component 15.

A presenting component 16 is, for example, a display for presenting images and characters, a speaker for outputting sound, or the like. The presenting component 16 outputs the content data from the display control component 15 as images, texts, audio, and the like. The user views digital content provided by a broadcast signal or a content server (not shown) by viewing images, texts, audio, and the like output from the presenting component 16.

The control component 17 controls respective functions of the receiving device 1. Specifically, the control component 17 receives various command signals from the interface component 18, the voice command processing component 2 and the like, and outputs control signals for controlling the respective functions of the receiving device 1 based on the various command signals received. For example, when the user uses the remote controller 10 to specify whether to watch the content of the broadcast signal or the content from the content server, the control component 17 receives a command signal from the remote controller via the interface component 18 to control the functions of the receiving device 1, causing the receiving device 1 to perform the user's specified action. In addition, in FIG. 2, data interaction may be performed between functional modules that are not particularly connected with the control component 17.

The interface component 18 is an interface for receiving a command signal from the remote controller 10 or the like, or for outputting a control signal from the control component 17 or the like to an external device. For example, the interface component 18 receives a command signal from a switch (not shown) of the receiving device 1, the remote controller 10, and the like, and outputs the command signal to the control component 17 of the receiving device 1. Instead of the remote controller 10, it may also have an interface for receiving a command signal from a terminal such as a smartphone (not shown). In addition, the interface component 18 has an interface for connecting with an external device, and may be, for example, an interface for connecting the receiving device 1 with an external record and playback device.

In addition, the interface component 18 in the embodiments of the present disclosure includes, for example, a microphone for receiving voice from outside of the receiving device 1. The interface component 18 may output the voice received by the microphone as digitized voice digital data (also referred to as voice data in some cases) by analog/digital conversion (A/D conversion) or the like.

The record and playback component 19 is, for example, a record player or an HDD recorder, and can record and play content data such as audio and video received from a broadcast signal, the Internet, or the like, for example. In addition, although FIG. 2 shows an example that the record and playback component 19 is in the receiving device 1, the record and playback component 19 may be an external device connected with the receiving device 1, for example, may be a Set Top Box, Sound Player, PC, etc., capable of recording and playing content data.

The data storage component 101 is, for example, a memory, or may be a database for storing various data. The data storage component 101 stores viewing information of the receiving device 1, analysis results obtained from the viewing information, model numbers, various functions, and other information specific to the receiving device 1 (referred to as receiving device data in some cases).

The voice command processing component 2 outputs the voice data received from the interface component 18 to the server 3 via the communication component 13, and receives information related to the local instruction data from the server 3. In addition, the voice command processing component 2 of the present embodiments generates a control signal based on the information related to the local instruction data from the server 3, and outputs the generated control signal to the control component 17, etc.

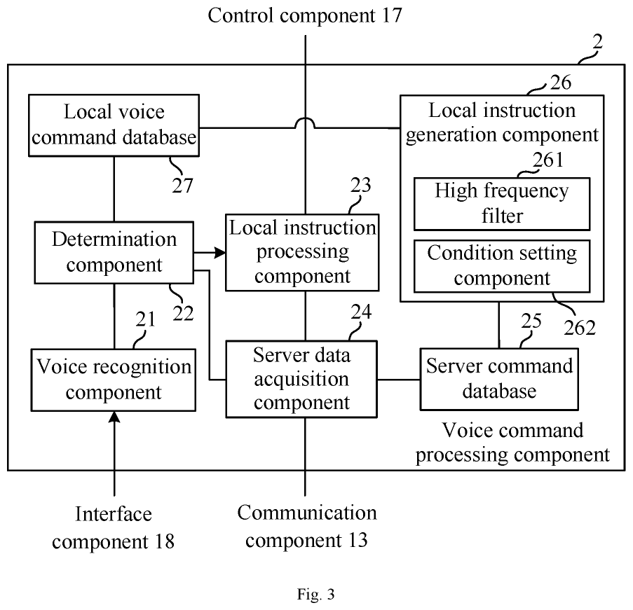

FIG. 3 is a functional block diagram showing a structure of a voice command processing component according to some embodiments.

The voice recognition component 21 performs voice recognition on voice data from the interface component 18 and outputs text data. In voice recognition technology, a method such as a Hidden Markov Model (HMM) is generally used. However, there are two approaches, one is a specific character string recognition approach in which HMM is applied to “character string” in the text as an object, the other approach is that converting “1 character” in the voice data via HMM to text. In the present embodiments, the above two approach are used. The voice recognition component 21 can detect any character string when the approach of converting to text is used, and can modify or increase a character string of a recognition object at any time when the specific character string recognition approach is used.

The determination component 22 determines whether text data output from the voice recognition component 21 is stored in the local voice command database 27. When determining that there is data of a voice command corresponding to the text data (data of a local voice command), the determination component 22 determines the local voice command as a voice command, and outputs a control signal, etc., to the control component 17, where the control signal enables the execution of a local instruction associated with the voice command. The local voice command is a voice command associated with a local instruction of the receiving device 1 and stored in the local voice command database 27. In addition, for example, a wake-up or trigger voice for starting voice recognition and the like may be pre-configured in the receiving device 1 as a local voice command.

The local instruction processing component 23 outputs the local instruction associated with the local voice command, the local instruction associated with server command information acquired from a server data acquisition component 24, and the like, to the control component 17 based on the control signal from the determination component 22.

The server data acquisition component 24 requests the server 3 for the server command information, and receives the server command information from the server 3. The server command information is configured for generating a local voice command, and includes a local instruction of the receiving device 1 selected by the server 3 based on input voice data or a voice command obtained by performing voice recognition on the voice data.

The server command database 25 comprises, for example, a memory, and may be a database that stores the server command information and the like received from the server 3.

A local voice command generation component 26 generates information of the local voice command based on the server command information stored in the server command database 25. When generating the local voice command, the local instruction processing component 23 may consider a usage frequency of the voice command, command processing priorities, and the like. The usage frequency of the voice command may be, for example, a value that is counted every time the voice recognition component 21 receives or recognizes a voice command registered in the server command database 25 or the like.

A high frequency filter 261 is a filter used when the local voice command generation component 26 generates a local voice command based on server command information. Specifically, the high frequency filter 261 counts and acquires a frequency (usage frequency) for each voice command every time the voice recognition component 21 receives a voice command registered in the server command database 25 or the like, for example. The high frequency filter 261 stores the count information in the server command database 25 or the local voice command database 27 or the like. The high frequency filter 261 extracts information of at least one local voice command from the data in the server command database 25 based on the counted usage frequency. The voice command extracted by the high frequency filter 261 is regarded as a local voice command, associated with the local instruction, and stored in the local voice command database 27.

The local voice command database 27 comprises, for example, a memory, and may be a database that stores information including the local voice commands output from the local voice command generation component 26, associated local instructions, and the like.

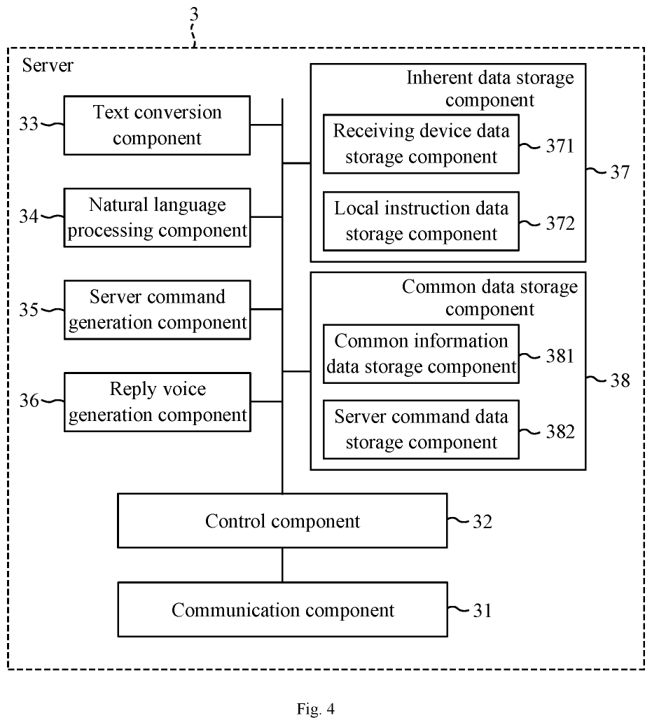

FIG. 4 is a functional block diagram showing a structure of a server according to some embodiments of the present disclosure.

The communication component in the server 31 is an interface for data communication with devices such as the receiving device 1 and the server 3 and the like on the network 5, and is configured with protocols such as TCP/IP and UDP/IP, for example.

The control component in the server 32 controls various functions in the server 3. Various data such as various control signals are received from an external device via the communication component in the server 31, analyzed and processed as required, and output to each functional module inside the server 3. In addition, various data are received from each functional module inside the server 3, and the data is modularized, formatted, and the like as required, and output to the communication component 31.

The text conversion component 33, for example, performs voice recognition on voice data from the user, and outputs the recognized voice as text data (referred to as recognized voice data in some cases). The same function as the voice recognition component 21 of the receiving device 1 may be used.

The natural language processing component 34 performs natural language processing on the text data input from the text conversion component 33, and generates or selects a server command (equivalent to a local instruction) corresponding to the processing represented by the text data. In natural language processing, the structure and meaning of an article in the form text data are analyzed, for example, data similar to the text data is extracted from data groups such as voice commands stored in the server command data storage component 382 of the server 3, and local instructions of the receiving device 1.

The server command generation component 35 creates server command information, where the server command information establishes an association between the text data (corresponding to a voice command) output from the text conversion component 33 and a local instruction of the receiving device 1 extracted by the natural language processing component 34 for the text data or the voice command. The local instruction of the receiving device 1 extracted by the natural language processing component 34 is sometimes referred to as a server command.

The reply voice generation component 36 may generate, for example, voice data of a short sentence or phrase when an input text command is a voice command such as a phrase to be output by voice from the speaker of the receiving device 1. In order to generate the voice data, processing such as voice synthesis may be provided. For example, when “the local instruction of the receiving device 1 for outputting the voice from the speaker” is extracted by the server command generation component 35, the server command generation component 35 may generate server command information including the extracted local instruction and “the voice data of the phrase”, etc., generated by the reply voice generation component 36. When receiving the server command information from the server command generation component 35, the receiving device 1 may output “the voice data of the phrase” via the speaker of the presenting component 16 and present “the voice data of the phrase” to the user as a voice. The receiving device 1 may establish and store the received “local instruction of the receiving device 1 for outputting the voice from the speaker” and the received “voice data of the phrase” in the local voice command database 27 by establishing an association between them. That is, the “voice data of the phrase” as the voice information and the local instruction between which the association is established is stored in the database. As such, when receiving a voice command from the user, the voice command processing component 2 executes the local instruction of “outputting the phrase 1 as a voice from the speaker” associated with the voice command in the local voice command database 27. The speaker of the presenting component 16 outputs the phrase 1 of the “voice data of the phrase” associated with the local instruction.

In addition, the receiving device 1 further has a function of voice synthesis. In this case, the server command generation component 35 transmits the extracted “local instruction of the receiving device 1 for outputting as voice from the speaker” to the receiving device 1 together with the text data of the phrase output as the voice. The receiving device 1 generates voice data through voice synthesis or the like according to the text data of the received phrase, and performs processing corresponding to the received local instruction at the same time. For example, when receiving the text data “Hello” of the phrase together with the local instruction of “outputting the received phrase from the speaker”, the receiving device 1 generates voice data of “Hello” and outputs the generated voice data of “Hello” via the speaker. The receiving device 1 may also store the text data of the received phrase in the local voice command database 27 together with the local instruction. As such, when receiving a voice command from the user, the voice command processing component 2 executes the local instruction of “outputting the phrase 1 as a voice via the speaker” associated with the voice command in the local voice command database 27, and sets the “text data of the phrase” associated with the local instruction as the voice data through voice synthesis, etc., and the voice data is output as voice via the speaker of the presenting component 16.

In addition, when both the receiving device 1 and the server 3 have the function of voice synthesis, the server command generation component 35 may take the extracted “local instruction of the receiving device 1 for outputting the voice from the speaker” as the text data of the phrase output by voice, and transmit the text data and the voice data thereof to the receiving device 1. The receiving device 1 can process the voice data according to a local instruction (server command), or set the text data as voice data and process the set voice data through voice synthesis or the like.

The inherent data storage component 37 comprises, for example, a memory, or may be a database for storing data associated with the receiving device 1. In addition, when a plurality of receiving devices 1 are connected with the network 5 and the server 3 is shared by the plurality of receiving devices 1, the inherent data storage component 37 may store the data associated with each of the plurality of receiving devices 1 respectively. The data stored in the inherent data storage component 37 may be acquired from the receiving device 1 via the network 5.

The inherent information of the receiving device 1 from the receiving device 1 is stored in the receiving device data storage component 371. For example, the following data are stored: number of the receiving device 1, various functions (recording functions, etc.) of the receiving device 1; the channel information (may also include the difference between external inputs such as broadcast programs, video play, and the network 5, etc.) currently presented in the receiving device 1; information on broadcast channels (channel number, broadcast station name, etc.) that the receiving device 1 can receive; recording schedule information of programs that can be recorded by the receiving device 1; and recorded content information recorded by the receiving device 1.

The local instruction data storage component 372 stores information of the local instruction inherently provided in the receiving device 1. The information of the local instruction may be acquired from the receiving device 1 via the network 5, and stored in the local instruction data storage component 372 for each receiving device 1. In addition, when the plurality of receiving devices 1 are the same product, since the provided local instructions are the same, the operator of the server 3 may directly input the information of the local instructions to the server 3. When a product information server or the like, not shown, that discloses product information of the receiving device 1 connected with the network 5 is provided, the server 3 may acquire information of local instructions from the product information server via the network 5.

The common data storage component 38 may be a database of data that can be shared by the plurality of receiving devices 1 connected with the network 5.

The common information data storage component 381 may be a database of data that can be acquired from an external device or the like connected with the network 5. For example, it is information of a program guide that can be viewed through digital broadcasting. When the receiving device 1 can acquire the program guide or the like from a broadcast signal, the server 3 may acquire the program guide from the receiving device 1 via the network 5.

The server command data storage component 382 may be a database in which server command information generated by the server command generation component 35 is stored. In addition, the server command generation component 35 may use the database of the server command data storage component 382 as reference data when generating the server command information.

### The First Embodiment

In the present embodiments, an example will be described in which an external device such as the server 3 performs voice recognition on voice data from the user to obtain voice commands, and the voice commands are accumulated in the receiving device 1, and the local instruction of the receiving device 1 is executed via the accumulated voice commands (local voice commands).

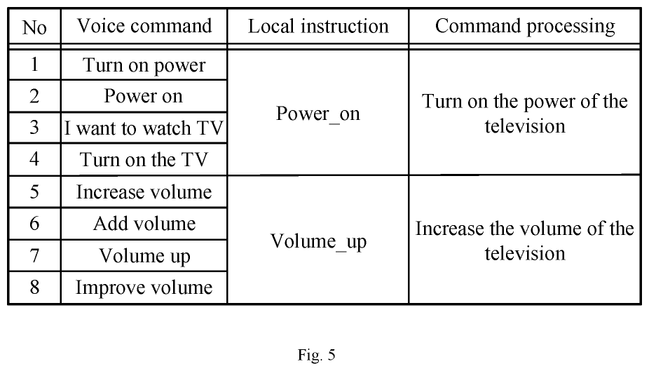

FIG. 5 is a diagram showing examples of voice commands processed by the voice command processing component according to the first embodiment. The voice commands that can be used by the receiving device 1, the local instructions that can be executed according to the voice commands on the left, and the command processing executed in the receiving device 1 according to the local instructions on the left are shown for each row.

For example, in an example of the No. 1 row, when the voice command “turn on the power” is recognized in the voice command processing component 2, the local instruction of “power_on” is input to the control component 17, and the control component 17 executes “power_on”, thereby the command processing of “turn on the power of the television” is executed. Therefore, when the user speaks “turn on the power”, the power of the television (the receiving device 1) is turned on.

In this embodiment, a plurality of voice commands may be associated with one local instruction. For example, the voice commands of No. 2, No. 3, and No. 4 in FIG. 5 are associated with the local instruction of “power_on”, and a plurality of voice commands can be used for the local instruction of “power_on” of the receiving device 1. The voice commands of No. 5 to No. 8 are associated with the local instruction of “volume_up”, which is an example of executing the command processing of “increase the volume of the television” in the receiving device 1 by issuing the voice commands of No. 5 to No. 8 from the user.

Hereinafter, the operations of this embodiment will be described with reference to the drawings.

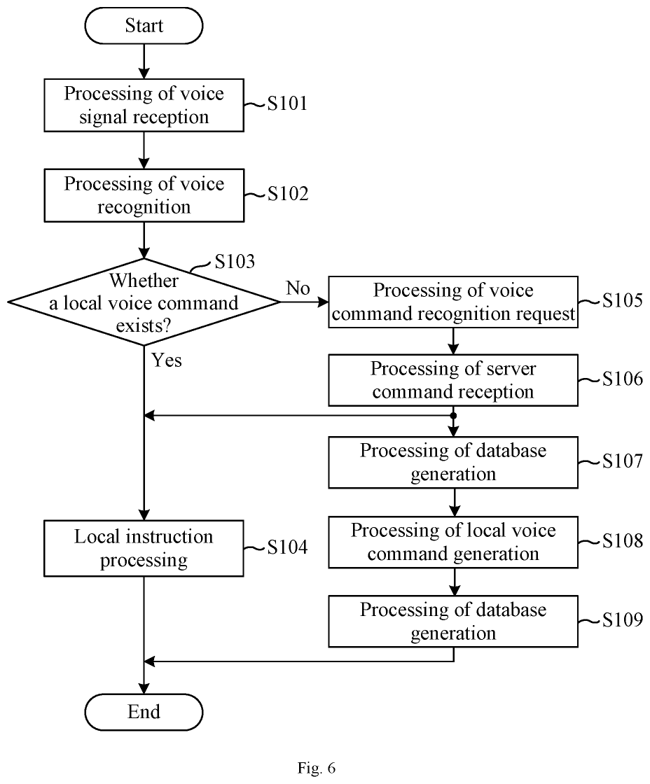

FIG. 6 is a flowchart showing an example of processing operations for a voice signal by the voice command processing component according to the first embodiment.

When a user issues a voice command, voice data is input to the voice command processing component 2 through the microphone of the interface component 18 (S101). The voice data is input to the voice recognition component 21, and converted into text data by voice recognition (S102). The text data is input to the determination component 22, and the determination component 22 determines whether a local voice command corresponding to the text data input to the local voice command database 27 exists (S103). When determining that a local voice command corresponding to the text data input to the local voice command database 27 exists, the determination component 22 outputs the local instruction associated with the local voice command to the control component 17 (“Yes” in S103). The control component 17 executes the input local instruction (S104). In S103, the condition that the text data input into the determination component 22 and the local voice command of the local voice command database 27 are completely consistent may be regarded as a condition of “Yes”, and even if there are some differences, it can be regarded as a condition of “Yes”. The condition in S103 may be set by the user.

On the other hand, when determining that there is no local voice command corresponding to the text data, the determination component 22 outputs the voice command recognition request together with the voice data from which the text data is obtained, from the server data acquisition component 24 to the server 3 (S105). The server data acquisition component 24 receives server command information from the server 3 (S106).

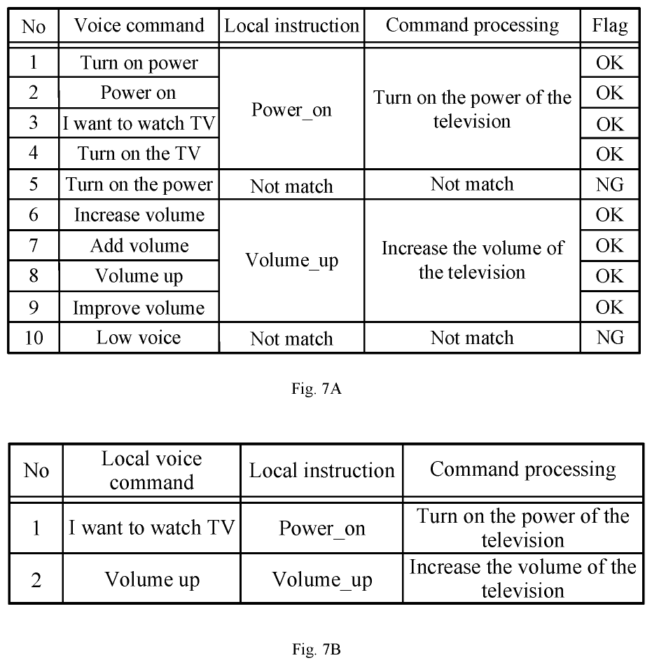

FIG. 7 is a diagram showing an example of a database in the local voice command database of the receiving device according to the first embodiment. FIG. 7A shows, in each row, voice commands received by the receiving device 1, local instructions of the receiving device 1 that can be executed according to the voice commands on the left, and command processing executed by the receiving device 1 according to the local instructions on the left. The rightmost flag (Flag) is flag information given by the server 3 to the voice command on the same row. For example, Flag in FIG. 7A shows that the server determines the voice commands on the same row are valid (OK) or invalid (NG) based on the condition. For example, No. 5 and No. 10 of FIG. 7A show voice commands that cannot be associated with local instructions in the server 3, and are set to Flag=NG. The conditions for setting the Flag are not limited to the above-mentioned conditions, and may be set in other ways. In addition, the value of the Flag may not be a value represented by OK or NG, etc. In addition, in the case where the input voice command cannot be recognized on the server like No. 5 and No. 10 (the corresponding local instruction is not found), the server 3 may feedback a local instruction (server command) equivalent to a retry to the receiving device 1, and shows a local instruction (server command) of a reply message such as “please say it again” to the receiving device 1. The receiving device 1 may execute processing according to the received server command, or wait for a user's command.

Returning to FIG. 6, the server command information received from the server 3 in S106 may be one row or multiple rows of voice commands shown in FIG. 7A.

For example, a description will be given of a case where the server data acquisition component 24 receives server command information including only No. 3 in FIG. 7A as one row of voice command. The server data acquisition component 24 outputs the local instruction of “power_on” included in the server command information to the control component 17 to cause the control component to execute the local instruction of “power_on”. Additionally, at the same time, the server data acquisition component 24 outputs server command information including only No. 3 to the server command database 25. The server command database 25 stores the input server command information in the database (S107). The local voice command generation component 26 confirms whether the voice command included in the server command information stored in the server command database 25 has been stored in the local voice command database 27, and if not confirmed, the voice command included in the server command information is stored in the local voice command database 27 as the local voice command (S108, S109).

FIG. 7B shows the data of the local voice commands when each local instruction is extracted one by one on the basis of frequencies. FIG. 7B shows that “want to watch TV” is selected as a local voice command for the local instruction of “power_on” for No. 3, and “volume_up” is selected as the local voice command for the local instruction of “volume_up” for No. 2.

In addition, according to the database stored in the server command database 25, the database of the local voice command database 27 can also be created by using the usage frequency of voice commands.

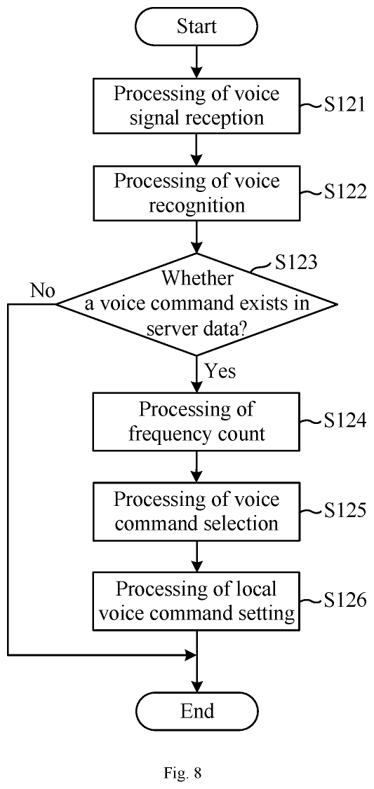

FIG. 8 is a flowchart showing an example of processing operations for creating local voice data by the voice command processing component according to the first embodiment. It is assumed that the data of FIG. 7A has been stored in the server instruction database 25. When the user issues a voice command, voice data is input to the voice command processing component 2 through the microphone of the interface component 18 (S121). The voice data is input to the voice recognition component 21, and converted into text data by voice recognition (S122). The text data is input to the high frequency filter 261, and the high frequency filter 261 determines whether a voice command corresponding to the input text data exists in the server command database 25 (S123). When the high frequency filter 261 determines that a voice command corresponding to the input text data exists in the server command database 25, the count of the voice command is incremented by 1 as the usage frequency (S124).

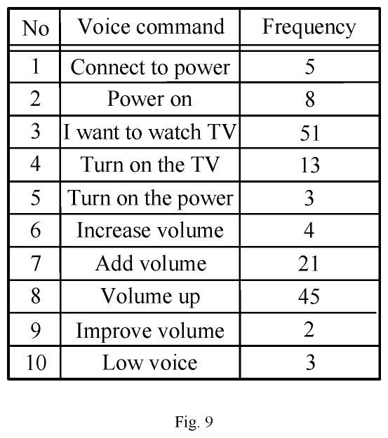

FIG. 9 is an example of local voice data stored in the voice command processing component of the first embodiment, and shows an example of data of respective usage frequencies of respective voice commands. For example, the usage frequency of the voice command of “turn on the power” of No. 1 is 5 times, and the usage frequency of the voice command of “volume_up” of No. 8 is 45 times.

Returning to FIG. 8, the high-frequency filter 261 selects a local voice command for each local instruction from the voice commands accumulated in the server command database 25 based on the usage frequency (S125). The voice commands extracted by the high frequency filter 261 are stored in the local voice command database 27 as local voice commands (S126). The local voice commands may be stored in the local voice command database 27 as shown in FIG. 7B.

With the above steps, it may accumulate server command information obtained using external (server 3) voice recognition for voice data received from the user into the receiving device 1, and to execute the local instruction of the receiving device 1 by using the voice command (local voice command) extracted from the accumulated server command information.

Hereinafter, an example of operations of the server 3 in the present embodiments will be described.

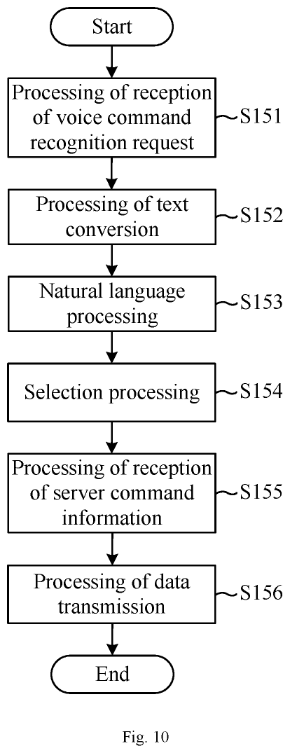

FIG. 10 is a flowchart showing an example of processing operations for voice data by the server according to the first embodiment, and shows the processing operations of the server 3 between S105 and S106 in FIG. 6 as the processing of the voice command processing component 2.

The voice command processing component 2 transmits a voice command recognition request (S105 in FIG. 6) together with the voice data. When the control component 32 of the server 3 receives the voice command recognition request, the control component 32 outputs the voice data simultaneously received to the text conversion component 33 (S151). The text conversion component 33 performs voice recognition on the voice data, converts the voice data into text data, and outputs the text data to the natural language processing component 34 (S152). The natural language processing component 34 performs natural language processing on the input text data, and determines whether a local instruction corresponding to the processing represented by the text data is stored in the local instruction data storage component 372 (S153).

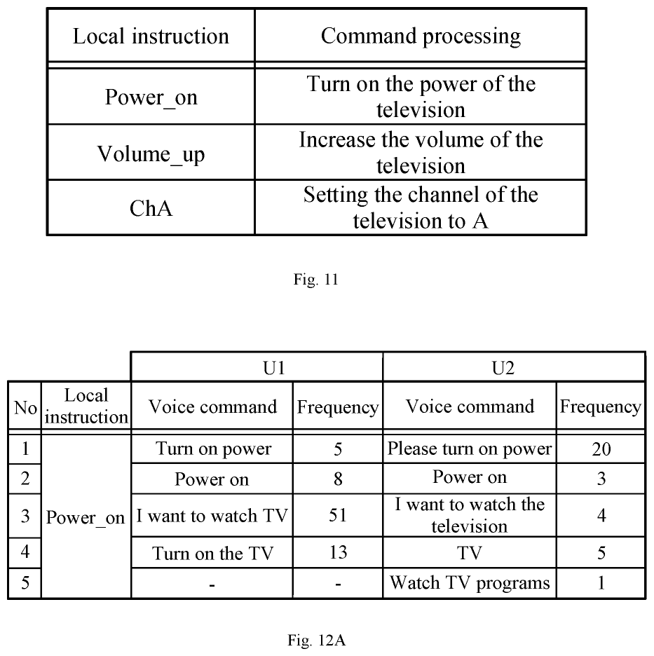

FIG. 11 is an example of a database stored in the server according to the first embodiment, and is an example of data related to the local instruction of the receiving device 1 stored in the local instruction data storage component 372 of the server 3. As shown in FIG. 11, the “local instruction” of the receiving device 1 and the “command processing” executed by the local instruction may be stored in each row.

Returning to FIG. 10, the natural language processing component 34 compares the meaning, etc., extracted from the input text data with the data in FIG. 11, and selects a local instruction that is similar to the meaning extracted from the input text data (S154). When a local instruction corresponding to the text data is found, the server command generation component 35 sets a value of e.g., “1”, for indicating the Flag “OK”, which includes server command information including the Flag (S155). The server command generation component 35 transmits the server command information from the communication component 31 to the receiving device 1 (S156). In the receiving device 1, the voice command processing component 2 receives the server command information (S106 in FIG. 6).

With the above steps, the voice command processing component 2 can acquire the server command information from the server 3 and execute the voice command even if the voice command processing component 2 cannot respond to the received voice command. In addition, the voice command processing component 2 accumulates the server command information in its own memory or the like, so that the voice command processing component 2 can use the voice command without going through the server 3 when the same voice command is received.

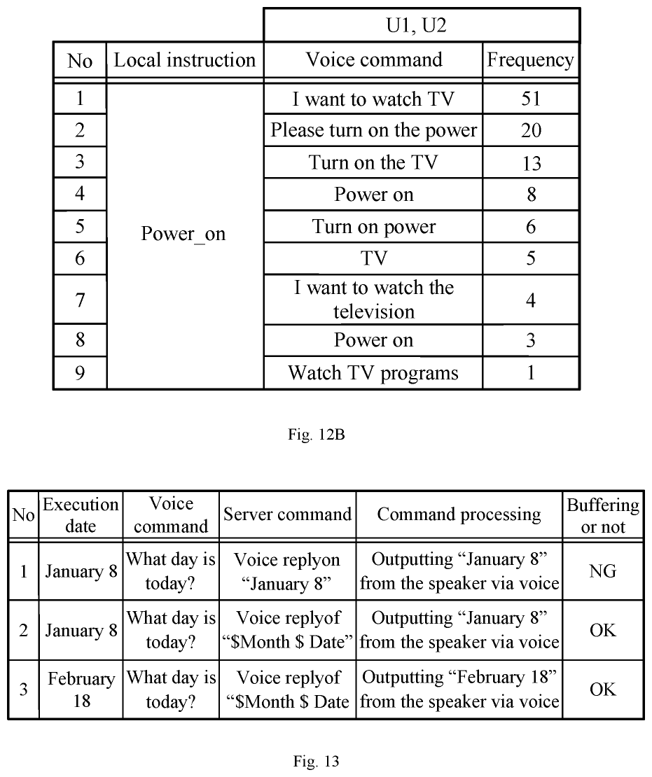

FIGS. 12A and 12B are examples of a database used by the voice command processing component of the first embodiment to process voice commands received from multiple users, and is an example of a database when multiple users use one receiving device 1. This database may also be stored in the server command data storage component 382.

In the voice command processing component 2, when the high frequency filter 261 is used in the generation of the local voice command, if the user is not identified, only the voice command of the user who frequently watches TV may be regarded as the local voice command and registered.

FIG. 12A is an example of a database of voice commands for local instructions when the receiving device 1 can recognize the user who issued the voice command. As in this example, the voice commands are database for each recognized user, the usage frequency is counted for each voice command, and the high-frequency filter 261 is applied for each user, to thereby generate a local voice command according to the usage frequency for each user. FIG. 12B is an example of a database in the case of combining the voice commands of all users in the voice commands of FIG. 12A, and is the same database as the example shown in FIG. 9.

FIG. 13 is a diagram showing an example of voice commands which can be processed by the voice command processing component according to the first embodiment, and is an example of a local voice command that can be complemented by the voice command processing component 2. Each row shows the “execution date” of the voice command, the “voice command” executed on the execution date on the left, and the “server command” processed according to the voice command on the left (equivalent to a local instruction of the receiving device 1), “command processing” which is processed according to the server command on the left, and “buffering or not” which indicates whether the server command on the left can be buffered.

Additionally, in the case where the server command for the voice command is always a fixed reply, information indicating that buffering is to be performed may be set in the “buffering or not” information. On the other hand, in the case where the server command for the voice command is limited to a current reply (for example, depending on the date and time) such as “please tell me the name of the program which is being watched now”, information indicating that the server command will not be buffered may be set. In addition, the “buffering or not” information may be set to “Flag” in the database shown in FIGS. 7A and 7B, and in this case, when the server 3 determines that the server command will be “buffered”, the Flag may be set to True, and when the server 3 determines that the server command will “not be buffered”, the Flag may be set to False.

The No. 1 row is an example of a case where, for example, when the user issues a voice command of “What day is today?” on the execution date of “January 8”, the voice command processing component 2 in the receiving device 1 receives a server command of a “voice reply of “January 8”” from the server 3 according to a voice command recognition request. When the voice command processing component 2 outputs the received server command (local instruction) to the control component 17, the control component 17 executes command processing of “voice output “January 8” from the speaker”, and the speaker of the presenting component 16 outputs the voice of “January 8”.

If the execution date changes, the reply content of the server command of the “voice reply of “January 8”” will change. That is, like whether to set the buffer on the No. 1 row is set as “NG”, the server command of the “voice reply of “January 8”” may be regarded as information that cannot be buffered, or information that has no meaning to be buffered.

Therefore, as shown in the No. 2 row, the server 3 creates a server command (referred to as a variable server command) by setting the variable part as a variable in the form of “voice reply of “$Month $ Date””. In addition, the variation of the server command may be performed by the server 3 or by the voice command processing component 2. In the case that it is performed by the voice command processing component 2 or for example, the server command on the No. 1 row is received, the server command of “voice reply “January 8”” may be stored in the server command database 25. The local voice command generation component 26 associates the “voice reply of “$ Month $ Date”” as a local instruction for the local voice command of “What day is today?” Accordingly, as shown in the No. 3 row, when the user issues the voice command of “What day is today?” on the execution day “February 18”, the voice command processing component 2 can perform the voice reply of “February 18” via the speaker of the presenting component 16 based on the association established among the local instruction, the “voice reply of “$ Month $ Date”” and date information obtained from broadcast signals, etc., or present the voice reply of “February 18” on the display. The receiving device 1 or the voice command processing component 2 may be capable of generating voice such as synthesized voice.

The variable server command of the No. 2 row and No. 3 row does not depend on the execution date. Thus, the item of “buffering or not” may be both set to “OK” to enable buffering. In addition, although FIG. 13 shows the example of the local instruction depending on the execution date, it is not limited to this example. For example, the voice command processing component 2 can complement the local instruction depending on the time, the season, the context of the command etc.

Through the above steps, the server 3 (cloud server or the like) performs voice recognition on voice data received from the user to obtain voice commands, and the voice commands are associated with local instructions, so that it may execute the local instructions of the receiving device 1 by using the voice commands that cannot be responded by the receiving device 1 previously.

Generally, voice recognition performed by a cloud server or the like has a function of extracting sound waves, such as “increase the volume”, “add volume”, “volume up”, and “improve volume” as voice commands for realizing volume up processing, from the user. However, in fact, there are fewer sound waves when one user uses it, and a constant sound wave is often existed. In such a case, the high-frequency filter 261 based on usage frequencies of the voice commands is used to determine a combination of voice frequently used (voice commands) and corresponding processing (local instructions), and a plurality of voice commands are set as local voice commands for one local instruction, thus local voice commands for each user can be set. In this case, it is not necessary to distinguish each user as shown in FIG. 12A. In some cases, by accumulating the voice commands received by each receiving device 1 shown in FIG. 9, the high frequency filter 261 is applied to the accumulated voice commands, whereby user identification is also performed. In addition, by continuously setting and accumulating local voice commands, information related to local instructions, etc. in the receiving device 1 or the voice command processing component 2, the receiving device 1 or the voice command processing component 2 can detect voice frequently used at high speed, it may perform processing equivalent to natural language processing without using natural language processing, and to perform the target processing autonomously. Accordingly, it is not necessary to use the server 3, and it may shorten the processing time of voice recognition or the like in the receiving device 1 or the voice command processing component 2, and the like. Furthermore, the voice content (local voice command) set in the receiving device 1 or the voice command processing component 2 of the present embodiments can also be used offline thereafter.

### The Second Embodiment

In the present embodiment, an example is shown in which a server command generated by the server 3 for one recognized (or received) voice command is associated with a plurality of local instructions. Specifically, the local voice command generation component 26 determines the processing of the local instruction associated with one voice command based on the priorities in the condition setting component 262.

FIG. 14 is an example of server command information stored in the voice command processing component of the second embodiment, and shows the voice command of “I want to see giraffes” received by the server 3, and the server command of “output program K” generated and acquired by the server command generation component 35 in response to the voice command of “I want to see giraffes”, and the command processing of four local instructions that can be performed in the receiving device 1 for the server command of “output program K”. Furthermore, the frequency and the priority are shown in the same row for each command processing.

The local voice command generation component 26 determines command processing for the server command of “output program K” based on the priorities.

The local voice command generation component 26 may establish an association between voice commands and command processing which is performed in order of priorities, and store the command processing that is performed in order of priorities and the voice commands in the local voice command database 27. For example, in FIG. 14, since the priorities are set in descending order of rows No. 4, No. 2, No. 3, and No. 1, command processing is executed in the order of rows No. 4, No. 2, No. 3, and No. 1. More specifically, when the user speaks “I want to see giraffes”, the voice command processing component first executes the command processing of “display broadcast program K” on the No. 4 row. If the broadcast program K is being broadcasted at the time of execution, “display broadcast program K” can be executed, but if the broadcast program K is not being broadcasted, “display broadcast program K” cannot be executed. Therefore, depending on different conditions, the command processing associated with the voice command may or may not be executed. When the command processing on the No. 4 row cannot be executed, the command processing on the No. 2 row having the next priority is executed. Hereinafter, similarly, command processing is continuously executed in order of priorities in consideration of conditions, environments, contexts and the like. Conditions such as priorities for command processing may also be set by the user from the remote controller.

Through the above steps, the voice command from the user can be associated with a plurality of local instructions (command processing) according to the conditions of the receiving device 1 and various functional components in the receiving device 1. In addition, by giving priorities to the associated command processing, for example, the command processing can be executed in order of priorities, so that more appropriate command processing can be performed for the voice command from the user. In addition, instead of executing multiple command processing in order of priorities, one command processing with the highest priority may be associated with one voice command. How to use the priority for association may be set by the user from the remote controller or the like, or information regarding association may be downloaded from a server (not shown) connected with the network 5. The frequency shown in FIG. 14 may be the usage frequency of command processing, or, for example, the control component 17 or the like may calculate the frequency of command processing in advance, and the local voice command generation component 26 may determine priorities based on the frequencies.

### The Third Embodiment

In the present embodiment, an example in which the server 3 generates a plurality of server commands for one voice command is shown.

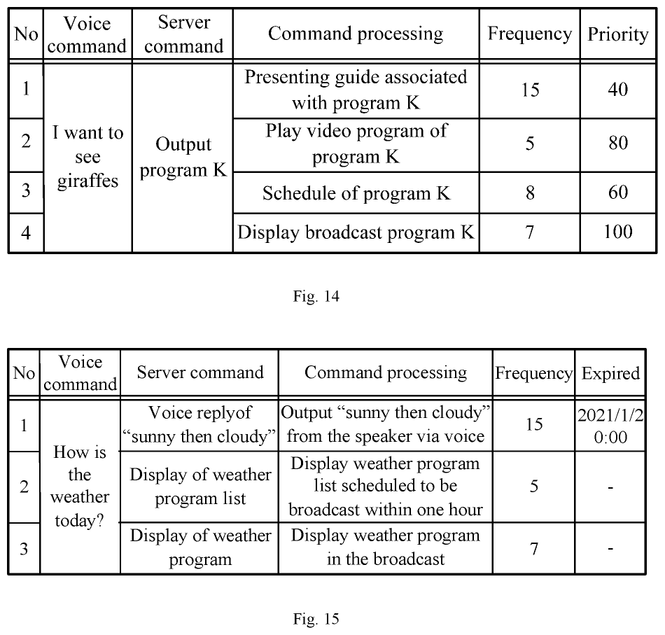

FIG. 15 is an example of a database stored in the voice command processing component according to the third embodiment, and is an example of data when the server 3 generates three server commands in response to the voice command of “How is the weather today?”. In FIG. 15, the command processing, frequency, and expired of the server command are shown in each row for each server command.

The frequency may be the usage frequency of the server command, and may be determined by the receiving device 1 or the server 3. In the case of determining by the server 3, for example, the database of the server command data storage component 382 may be used and the information from the plurality of receiving devices 1 may be used for determining. In addition, the server 3 can determine the frequency based on the frequency information from the plurality of receiving devices 1 by providing the server 3 with the usage frequencies of server commands (equivalent to local instructions) counted on the receiving device 1. Instead of using the frequency information from the plurality of receiving devices 1 together, the frequency information of the receiving devices 1 may be used separately, and a server command or a local instruction may be determined for each receiving device 1.

In the present embodiment, the local voice command generation component 26 basically determines the command processing executed by the receiving device 1 in the order of the frequencies, where the frequencies are used as the priorities. A condition such as expired is also considered. Expired indicates an expiration date of the command processing. For example, expired “2021/1/2 0:00” of the No. 1 row in FIG. 15 indicates that the server command and command processing of the No. 1 row are “valid until 0:00 on Jan. 2, 2021”. The server command of the “voice reply of “sunny then cloudy”” on the No. 1 row is a command depending on the time and date, and therefore this is an example of a condition of expired. In addition, “expired” may be set to “Flag” in the database shown in FIGS. 7A and 7B. In this case, the server 3 may determine the expiration date “expired” of the server command, and when the server command may be within the expiration date, the Flag is set to True, and when the server command has exceeded the expiration date, the Flag is set to False.

In the present embodiment, when the user issues a voice command of “How is the weather today?” before “2021/1/2 0:00”, the receiving device 1 executes the command processing on the No. 1 row. However, when the user issues the voice command of “How is the weather today?” after “2021/1/2 0:00”, the command processing on the No. 3 row with the next high frequency is executed. The method shown in the second embodiment can also be applied to the method of using the priorities and the like. In addition, in the command processing of the No. 1 row, the part of “sunny then cloudy” can be variable as shown in the first embodiment. In the case of variable, when the voice command processing component 2 receives the voice command of “How is the weather today?” from the user, regardless of expired, the latest weather information may be referred from the server (not shown) on the network 5 or the broadcast signal, etc., so that the speaker of the presenting component 16 outputs the latest weather information in the form of voice output.

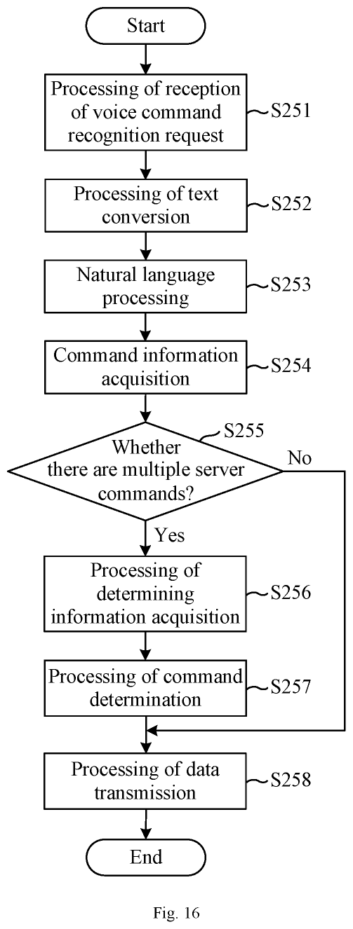

FIG. 16 is a flowchart showing an example of processing operations in a case where the server selects a server command from multiple server commands and transmits the server command to the voice command processing component according to the third embodiment, and is an example in which the server 3 selects a server command from multiple server commands according to information acquired from an external device such as the receiving device 1 and transmits the server command to the voice command processing component.

When the control component 32 of the server 3 receives the voice command recognition request from the voice command processing component 2, the control component 32 outputs the simultaneously received voice data to the text conversion component 33 (S251). The text conversion component 33 performs voice recognition on the voice data, converts the voice data into text data, and outputs the text data to the natural language processing component 34 (S252). The natural language processing component 34 performs natural language processing on the input text data, and determines whether information of a local instruction corresponding to the processing represented by the text data is stored in the local instruction data storage component 372 and the common data storage component 38 (S253). The server command generation component 35 acquires the information of the local instruction determined by the natural language processing component 34 (S254). The server command generation component 35 generates a server command based on the acquired information of the local instruction. When there are a plurality of generated server commands, the server command generation component 35 acquires inherent information of the receiving device 1 from the inherent data storage component 37 (“Yes” in S255, S256). The server command generation component 35 selects a server command to be transmitted to the receiving device 1 from the plurality of server commands based on the inherent information of the receiving device 1 (S257). For example, the server command on the No. 1 row in FIG. 15 may not be selected based on the fact that the inherent information of the receiving device 1 is determined, such as “prohibited voice output” and “speaker is invalid”. In addition, not only the inherent information of the receiving device 1 but also the data, such as program information, etc., of the common data storage component 38 may be used. For example, the server command on the No. 2 row in FIG. 15 may not be selected based on the fact that “there is no weather program scheduled to be broadcast within one hour” from the program information.

The server command generation component 35 includes server command information including the selected server command and the reply voice created by the reply voice generation component 36 as needed, and outputs the server command information to the voice command processing component 2 via the communication component 31 (S258).

Through the above steps, when the server 3 determines a plurality of local instructions corresponding to the input voice command, the server 3 can select a server command from the plurality of server commands based on the data in the inherent data storage component 37 and the common data storage component 38, etc., and provide the server command information including selected server command to the voice command processing component 2. The voice command processing component 2 registers the voice command acquired from the server command information provided by the server 3 and the server command (equivalent to a local instruction) associated with the voice command in the local voice command database 27, so as to perform command processing in the receiving device 1 that considers the data in the inherent data storage component 37 and the common data storage component 38 via the voice command from the user.

According to the present embodiment, the server 3 generates the server command information according to the data of the inherent data storage component 37 and the common data storage component 38, etc., so that information such as program name and broadcast station name does not need to be edited in the receiver device 1 in advance, and the information of the inherent data storage component 37 and the common data storage component 38 can be considered for the voice command from the user. As such, the user can not only use the voice command similar to a form of ordinary language (natural language), but also set the command processing of the voice command to match the user and the receiving device 1 of the user, only by using the receiving device 1 of the present embodiment.

For example, if the user speaks “I want to watch program A”, the server 3 confirms “scheduled to be broadcast on ch5 of digital broadcasting or scheduled to be distributed on the content server on the network 5 at Saturday 17:00 in the future” based on the program information, and further, at the same time, when it is determined that “connection to the network 5 is not available” based on the inherent information of the receiving device, the server command “schedule: Saturday 17:00 in ch5” is transmitted to the receiving device 1. At the receiving device 1, the voice command processing component 2 can either cause the control component 17 to execute the received server command as a local instruction, or may establish an association with the local voice command of “I want to watch program A” and store the local voice command in the local voice command database 27.

### Modification Embodiment

In the above-described embodiments, the configuration in which the receiving device 1 includes the voice command processing component 2 is shown. In the present modification embodiment, other configurations will be described.

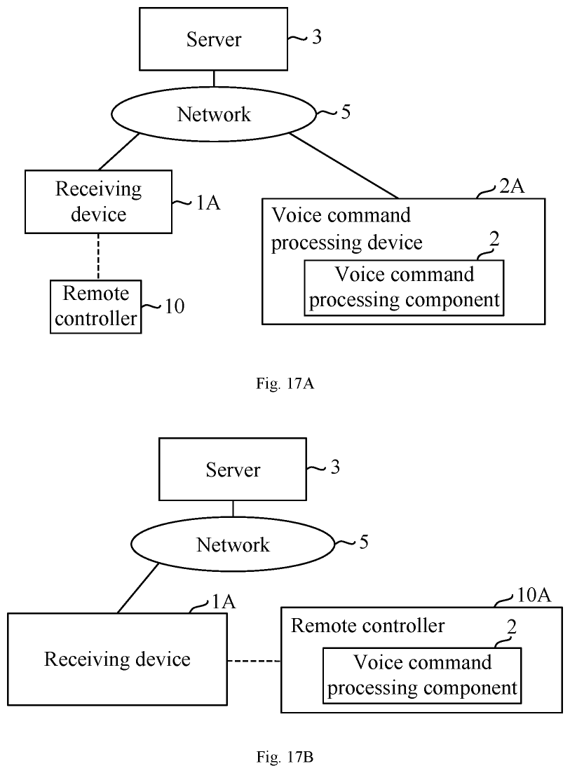

FIGS. 17A and 17B are functional block diagrams showing a structure of a system according to a modification embodiment.

FIG. 17A is an example where the voice command processing device 2A including the voice command processing component 2 enables the receiving device 1A to be controlled by a voice command.

The receiving device 1A corresponds to the receiving device in which the voice command processing component 2 is removed from the receiving device 1, but may be the same receiving device as the receiving device 1.

The voice command processing device 2A includes the functions of the voice command processing component 2 and a microphone, and may be a computer including a CPU and a memory. The voice command processing device 2A may include digital signal processing components, such as A/D conversion, DSP, etc., for processing audio signals output from the microphone. The voice command processing device 2A may be provided with a communication components (corresponding to the communication component 13 in FIG. 2), not shown, for communicating with the server 3. The local instruction output from the local instruction processing component 23 of the voice command processing component 2 may be input to the control component 17 of the receiving device 1A via the network 5.

In the modification of FIG. 17A, the user issues a voice command to a microphone (not shown) of the voice command processing device 2A. The voice received by the microphone is converted into voice data by A/D conversion or the like, and then the voice data is input to the voice command processing component 2. By performing the same processing operation as the flowchart shown in FIG. 6 in the subsequent voice command processing component 2, the same processing as the voice command processing of the above-described embodiments can be performed, and the same effect can be obtained.

According to the modification of FIG. 17A, the receiving device 1A can be remotely operated from the voice command processing device 2A via the network 5. In addition, by providing databases such as the server command database 25 and the local voice command database 27 of the voice command processing component 2 in the cloud server, not only the receiving device 1A of a specific user but also the receiving device 1A of other users can perform the same voice command processing (sharing of the voice command processing device 2A) is also realized, and the voice command processing device 2A can be easily moved (portable).

FIG. 17B is an example where a remote controller 10A including the voice command processing component 2 controls the receiving device 1A with a voice command.

The remote controller 10A is a remote controller including a voice command processing component 2 in the remote controller 10. The remote controller 10A includes a function of a microphone, and may include a computer including a CPU and a memory, and a digital signal processing structure such as an A/D converter, a DSP, and the like for processing a voice signal output from the microphone. The remote controller 10A may include a communication structure (corresponding to the communication component 13 in FIG. 2), not shown, for communicating with the server 3. In addition, when the remote controller 10A includes a communication structure such as Bluetooth capable of communicating with the receiving device 1A, the remote controller 10A may be connected to the network 5 via the receiving device 1A to communicate with the server 3. In addition, the local instruction output from the local instruction processing component 23 of the voice command processing component 2 may be input to the control component 17 of the receiving device 1A via a communication component such as Bluetooth, or may be used as a normal control signal of the remote controller from infrared rays or the like of the remote controller 10A to be transmitted to the receiving device 1A.

In the modification of FIG. 17B, the user issues a voice command to a microphone (not shown) of the remote controller 10A. After the voice command received by the microphone is converted into voice data via A/D conversion or the like, the voice data is input to the voice command processing component 2. By performing the same processing operation as the flowchart shown in FIG. 6 in the subsequent voice command processing component 2, the same processing as the voice command processing of the above-described embodiments can be performed, and the same effect can be obtained.

According to the modification of FIG. 17B, by issuing a voice command to the remote controller 10A of the user, the effects of the above-described embodiments can be easily obtained. The database, such as the server command database 25 and the local voice command database 27 of the voice command processing component 2, etc., may be installed in the receiving device 1A, a cloud server not shown, or the like. According to at least one of the above-described embodiments, a voice command processing circuit, a receiving device, a server, a system, a method, and a computer-readable non-transitory storage medium capable of adding locally processable voice commands can be provided.

In addition, the conditional parameters displayed on the analysis screen and the like shown in the drawings, the names, definitions, types, etc. of their options, values, evaluation indexes, etc. are shown as an example in the present embodiments, and are not limited to the examples shown in the embodiments.

Embodiments of the present disclosure further provide a computer-readable non-transitory storage medium, where computer instructions are stored in the storage medium, and when the computer instructions are executed by a processor, the voice data processing in the above-mentioned embodiments is implemented.

Several embodiments of the present disclosure are described, but these embodiments are shown as examples and are not intended to limit the scope of the present disclosure. These new embodiments can be implemented in various other forms, and various omissions, substitutions, and changes can be made without departing from the spirit of the present disclosure. These embodiments and modifications thereof are included in the scope and spirit of the present disclosure. Furthermore, among the respective constituent elements of the present disclosure, the case where the constituent elements are expressed in division, the case where a plurality of constituent elements are expressed together, or the case where they are expressed in combination are all within the scope of the present disclosure. In addition, a plurality of embodiments may be combined, and the embodiments constituted by the combination are also within the scope of the present disclosure.

In addition, in order to make the description clearer, in the drawings, the width, thickness, shape, etc. of each part may be schematically shown in comparison with the actual form. In the block diagram, data and signals may be exchanged between unconnected modules or even if they are connected in the direction of arrows. The processes shown in the flowcharts can also be realized by software (programs, etc.) or a combination of hardware and software that operates in hardware including an IC chip, a digital signal processor (Digital Signal Processor or DSP), or a computer such as a microcomputer. In addition, when the embodiment is expressed as control logic, when expressed as a program including instructions for causing a computer to execute, and when expressed as a computer-readable non-transitory storage medium in which the above-mentioned instructions are written in the present disclosure, the device of the present disclosure can also be applied. In addition, the names and terms used are not limited, and other expressions are included in the present disclosure as long as they have substantially the same content and the same spirit.

What is claimed is:

1. A receiving device for voice command processing, comprising:
a voice data receiving component, configured to receive voice data from a user;
a communication component configured to communicate with an external device;
a voice recognition component, configured to perform voice recognition on voice data and outputting a recognition result;
a determination component, configured to determine whether a first voice command corresponding to a first recognition result exists in a database of the receiving device, wherein an association is established between information of the first voice command for controlling the receiving device and information of a first local instruction inside the receiving device for command execution of the first voice command; and
a server data receiving component, configured to acquire information of the database from a server based on a determination result from the determination component.

2. The receiving device for voice command processing according to claim 1, wherein
the server data receiving component is further configured to: in response to the determination component determining no first voice command corresponding to the recognition result exists in the database, output a voice recognition request and the voice data to the server, and receive server command information, wherein the voice recognition request is used for requesting the server to perform voice recognition on the voice data, the server command information comprises a second local instruction associated with the server recognition result and a server recognition result, and the server recognition result is obtained by the server performing voice recognition on the voice data.

3. The receiving device for voice command processing according to claim 1, further comprising:
a local instruction processing component, configured to output the information of the first local instruction based on the determination result from the determination component.

4. The receiving device for voice command processing according to claim 2, further comprising:
a database operation component, configured for storing information of the second local instruction and the server recognition result in the database.

5. The receiving device for voice command processing according to claim 1, wherein the information of the first local instruction is associated with information of a second voice command whose corresponding second recognition result is different from the first recognition result.

6. The receiving device for voice command processing according to claim 1, wherein the information of the first local instruction is associated with information of a plurality of voice commands with different recognition results.

7. The receiving device for voice command processing according to claim 1, wherein the database operation component is further configured to: in response to the server command information for the first voice command being a fixed reply to the first voice command, set a first buffering indication for indicating that buffering the server command is to be performed; in response to the server command information for the first voice command being not a fixed reply, set a second buffering indication for indicating that the server command is not buffered.

8. The receiving device for voice command processing according to claim 1, wherein the first voice command is associated with a plurality of local instructions in the database of the receiving device.

9. The receiving device for voice command processing according to claim 8, wherein the plurality of local instructions associated with the first voice command are configured to output to the user in order of priorities.

10. The receiving device for voice command processing according to claim 8, wherein the plurality of local instructions associated with the first voice command are output to the user according to inherit information of the receiving device and common data of the receiving device.

11. A method for voice command processing in a receiving device, comprising:
receiving first voice data from a user;
performing voice recognition on the first voice data and outputting a first recognition result;
determining whether a first voice command corresponding to the first recognition result exists in a database of the receiving device to obtain a determination result, wherein an association is established between information of the first voice command for controlling the receiving device and information of a first local instruction inside the receiving device for command execution of the first voice command; and
in response to determining the first voice command exists in the database of the receiving device, output the first local instruction for command execution of the first voice command.

12. The method for voice command processing according to claim 11, further comprising:
in response to determining no first voice command corresponding to the recognition result exists in the database,
outputting a voice recognition request and the first voice data to the server, and receiving server command information, wherein the voice recognition request is used for requesting the server to perform voice recognition on the first voice data, the server command information comprises a second local instruction associated with the server recognition result and a server recognition result, and the server recognition result is obtained by the server performing voice recognition on the first voice data.

13. The method for voice command processing according to claim 11, further comprising:
outputting the information of the first local instruction based on the determination result.

14. The method for voice command processing according to claim 12, further comprising:
storing information of the second local instruction and the server recognition result in the database.

15. The method for voice command processing according to claim 11, wherein the information of the first local instruction is associated with information of a second voice command whose corresponding second recognition result is different from the first recognition result.

16. The method for voice command processing according to claim 11, wherein the information of the first local instruction is associated with information of a plurality of voice commands with different recognition results.

17. The method for voice command processing according to claim 11, further comprising: in response to the server command information for the first voice command being a fixed reply to the first voice command, setting a first buffering indication for indicating that buffering the server command is to be performed; in response to the server command information for the first voice command being not a fixed reply, setting a second buffering indication for indicating that the server command is not buffered.

18. The method for voice command processing according to claim 11, wherein the first voice command is associated with a plurality of local instructions in the database of the receiving device.

19. The method for voice command processing according to claim 18, wherein the plurality of local instructions associated with the first voice command are configured to output to the user in order of priorities.

20. The method for voice command processing according to claim 18, wherein the plurality of local instructions associated with the first voice command are output to the user according to inherit information of the receiving device and common data of the receiving device.
